(19) United States
(12) Patent Application Publication
(10) Pub. No.: US 2016/0010783 A1
(43) Pub. Date: Jan. 14, 2016

(54) DROGUE FOR CONFINED SPACES

(71) Applicant: PURE TECHNOLOGIES LTD., Calgary (CA)

(72) Inventors: Peter O. PAULSON, Calgary (CA); Adrian BLACK, Calgary (CA)

(21) Appl. No.: 14/770,540

(22) PCT Filed: Feb. 28, 2014
(86) PCT No.: PCT/CA2014/050150

§ 371 Date: Aug. 26, 2015

Related U.S. Application Data
(60) Provisional application No. 61/770,648, filed on Feb. 28, 2013.

(51) Int. Cl. F16L 55/40; F16L 55/38

(52) U.S. Cl. CPC F16L 55/40; F16L 55/38

(57) ABSTRACT

The invention provides a drogue which is particularly useful for pulling an object through a confined space which has fluid flowing in it, such as a conduit or pipeline. The drogue comprises a body panel, with an even number of wing panels extending outwardly from the body panel and spaced evenly around it, and securing means associated with the body panel and with the end of each wing panel remote from the body panel. The invention also provides a combination of a drogue and an object to be pulled by the drogue. The object may be for example, a cable to be laid in a conduit or pipeline, or an inspection device (tethered or untethered) for inspection of a conduit or pipeline.

### FIELD OF THE INVENTION

This invention relates to a drogue for use in a confined space such as a pipe or conduit, where the drogue is entrained in a fluid moving along the pipe or conduit and serves to pull an object through the pipe or conduit. The invention also provides a combination of a drogue and an object to be pulled by the drogue. The object may be for example, a cable to be laid in a conduit or pipeline, or an inspection device (tethered or untethered) for inspection of a conduit or pipeline.

### BACKGROUND

It is known to use fluid flowing through a pipe or conduit to move a drogue within the pipe or conduit. The drogue is attached to an object and the drag of the fluid against the drogue exerts a pull on the object. For example, a drogue can be used to deploy a cable in a pipeline or conduit, as shown in European Patent 0 442 626 (Grey et al), or to move an untethered inspection unit through a pipeline as shown in U.S. Pat. No. 4,495,808 (Fischer). It can also be used to move a tethered inspection unit within a conduit or pipeline, as shown in U.S. Pat. No. 5,084,764 (Day) and U.S. Pat. No. 6,889,703 (Bond). In the case of the tethered unit, the drogue urges the tethered inspection unit along with the fluid flow away from the location at which the drogue is tethered (called herein the “tether point”), and the unit is recovered by pulling the unit with a winch or the like back to the tether point, in opposition to the pull of the drogue.

Drogues in a pipe or conduit do not always provide an even or predictable pull on the object they are pulling. There may be changes in the fluid flow velocity as the drogue proceeds along the pipe or conduit or around bends or through narrow sections in it, and the drogue may contact the pipe wall or become partially deflated. Contact with the pipe wall is particularly deleterious when the object being pulled is an inspection device, as such contact may affect the readings of sensors being used to inspect the pipe, or may stir up sediment which prevents the obtaining of accurate pictures of the pipe wall by video or still cameras on the inspection device.

### BRIEF STATEMENT OF THE INVENTION

The invention provides a drogue which is particularly useful for pulling an object through a confined space with fluid flowing in it. The drogue comprises a body panel, with an even number of wing panels extending outwardly from the body panel and spaced evenly around it, and securing means associated with the body panel and with the end of each wing panel remote from the body panel.

The invention also provides a combination of a drogue and an object to be pulled by the drogue. The drogue comprises a body panel, with an even number of wing panels extending outwardly from the body panel and spaced evenly around it, and securing means associated with the body panel and with the end of each wing panel remote from the body panel. The object may be, for example, a cable to be laid in a conduit or pipeline, or an inspection device (tethered or untethered) for inspection of a conduit or pipeline. The drogue is intended to urge the object to move downstream, ie in the direction of the fluid flow in the conduit or pipe. The securing means associated with the body panel are attached by flexible members to a first portion of the object, and the securing means associated with the ends of the wing panels are attached by flexible members to a second, more upstream portion of the object.

In preferred embodiments, there is a hole in the centre of the body panel. This permits some fluid to escape from upstream from the drogue into the pipe or conduit downstream from the drogue. While this reduces the pull force of the drogue, it is found to help keep the drogue in the central portion of the conduit or pipe and reduces undesired movement toward the pipe or conduit side. Where the object is an inspection device, the hole also assists in giving unimpeded forward view to a camera mounted on the inspection device.

In a particularly preferred embodiment, the hole in the centre of the body panel is large enough so that a portion of the object can protrude through it.

### DESCRIPTION OF THE DRAWINGS

The invention will be described with reference to the accompanying drawings, in which;

FIGS. 1-3 show plan views of drogues according to the invention having four wing panels.

FIG. 4 shows a plan view of a drogue according to the invention having six wing panels.

FIG. 5 shows a perspective view of the drogue of FIG. 2 pulling an object through a conduit or pipeline. In the figure, the object is a tethered inspection device.

FIG. 6 is a fragmentary plan view, partially cutaway and not to scale, along the line 6-6 of FIG. 5.

### DETAILED DESCRIPTION OF THE INVENTION

The drogue according to the invention is made from panels of any suitable material for drogue construction which is compatible with the fluid in the conduits or pipelines with which it is to be used. Thus, a material should be chosen that does not decompose in such fluid or pollute the fluid or the like. Siliconized nylon sailcloth is preferred for the panels because it is lightweight and fairly tough, but other materials such as polyethylene terephthalate sailcloth or aramid fibre sailcloth or some non-woven sheet plastics can be used. Any suitable thickness can be used, depending on sailcloth chosen and the intended use. The panels can be reinforced by having webbing, for example nylon webbing, sewn to them at their edges and at places where securing means are attached. Such reinforcement is common in the drogue art.

The securing means are used to attach an elongated flexible member such as a cord or string to the drogue. The securing means should not deform or stretch unduly under the conditions of use. Generally, a grommet or a nylon or other fabric tape sewn into a loop through which the flexible member can pass is found to be a satisfactory securing means. With such an arrangement, the elongated flexible member can be looped back and tied to itself so it will not detach from the drogue. Other securing means and methods of attachment of the flexible member to such securing means will be evident to persons skilled in the art.

The elongated flexible member can be for example a tape, cord or string. Nylon string has been found particularly convenient for use, and the flexible members will be described in the description of the particular embodiments as “strings”.

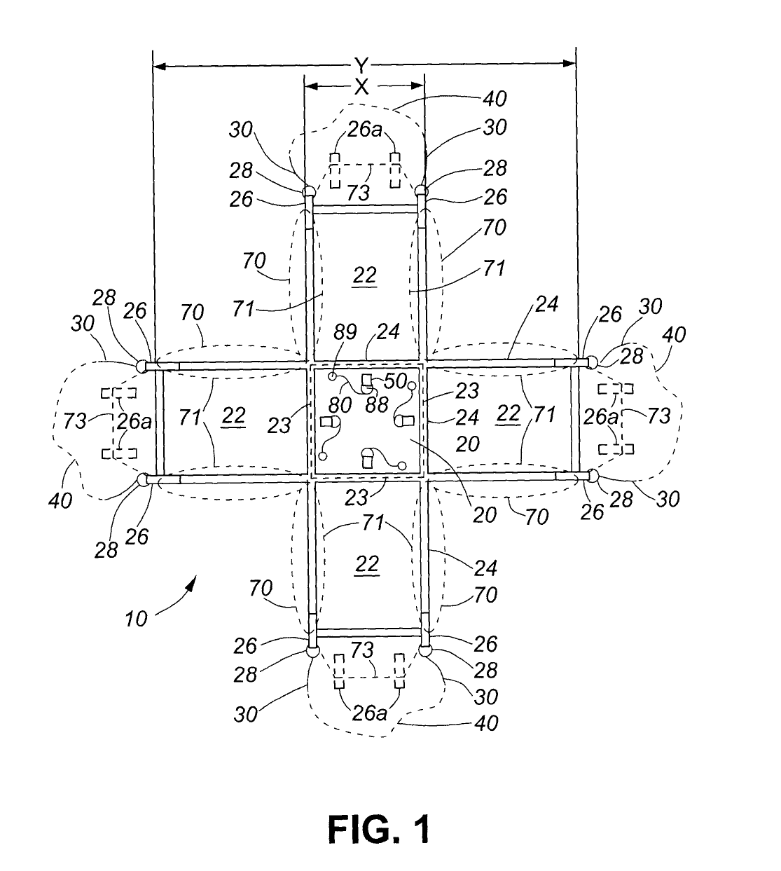

One embodiment of the drogue is shown in FIG. 1 in plan view at 10. It is spread out flat so all panels can be seen. The body (central) panel 20 is square. On each side of the square body panel 20 is attached, as by sewing at 23, a wing panel 22. As an alternative to sewing, the wing panels and body panel can be cut out together, as a single piece, from a sheet of fabric. Each wing panel 22 is the same size as the other wing panels. It is preferred that the wing panel extends the full side of each body panel. Together, the wing panels and the central panel when spread out flat have an overall shape of a cross or plus sign (+). The wing panels are generally rectangular, but can depart slightly from true rectangles by having a smoothly curved side edge as shown by dashed lines 70 (when it is desired to increase the cross-sectional area of the panels and hence their drag) or as shown by dashed lines 71 (when it is desired to decrease the cross-sectional areas slightly to permit more fluid to escape). The edges of the wing panels are optionally but preferably reinforced, as for example by having a ⅜ inch nylon webbing 24 sewn along them. Reinforcement 24 is also preferred at the corners of the body panel and where the body panel and wing panels join, to prevent tearing.

The drag on the panels of a drogue which pulls an object in a conduit or pipeline exerts a pulling force on the object to move it in the direction of the fluid flow. Such drag will be described as “pulling force” to indicate that it is a desirable thing to have (as opposed, for example, to drag arising from frictional contact with the conduit or pipe wall).

Each wing panel has securing means 26 on the two corners of the wing panel which are not joined to the body panel. The securing means shown is a 0.5 inch nylon tape folded back on itself and sewn into a loop which extends beyond the wing panel so that a string can be inserted into it, although other securing means as discussed above could be used instead. In FIG. 1, nylon strings 30 have been threaded through the loops of securing means 26 and have been tied securely to themselves, for example by bowline knots which form loops 28, so that they will not detach from the drogue. In preferred embodiments, the dangling ends of strings 30 extending from each wing panel are in fact parts of the same string, as is shown by dashed loop 40 joining them.

When the drogue is to be used in a constrained conduit with sharp bends, it is sometimes advisable to put extensions, shown in dashed lines at 73, on the side of each of wing panels 22 remote from the body panel 20 (called herein the “distal end”). If such extensions are used, securing means 26a are put on the extensions, and these replace the previously described securing means 26. The purpose of the extensions is to pull the distal ends closer to the object to be pulled when the drogue is in use. The pulling force and stability when extension 73 is used are not as good as when it is not used, but the likelihood of contact with the walls of the conduit in a sharp bend may be reduced. The extensions are typically in the form of isosceles trapezoids, and typically have a length of their shorter parallel side of about half the width of the rectangular wing portion 22, They extend beyond the rectangular wing portion at its distal end about ⅕ to ⅓ of the length of the rectangular wing portion 22.

Four securing means 50 are symmetrically placed on body panel 20a at the mid points of the sides thereof. In the embodiment shown, they are loops of nylon tape. Strings 80 are threaded through the loops (one through each loop) and are tied in place securely, as for example by bowline knots. The strings are of equal length and preferably terminate in loops tied by bowline knots 89 to facilitate attachment to the object to be pulled. (For clarity, reference numerals 88 and 89 are shown with respect to only one string 50.) The string lengths are chosen so that effective length of the strings 80 are the same after the knots are tied.

If the drogue is to be used to pull an inspection device, the centre of body panel 20 (or indeed the entire panel) can be made of a transparent material chosen for low light reflectivity and distortion. The use of a transparent sheet permits light from a light source on the inspection device to pass through the body panel 20a and illuminate the portion of the pipe or conduit downstream of the device when the drogue is assembled on the device. It also permits still or video pictures to be taken of that part of the pipe or conduit by the still or video camera.

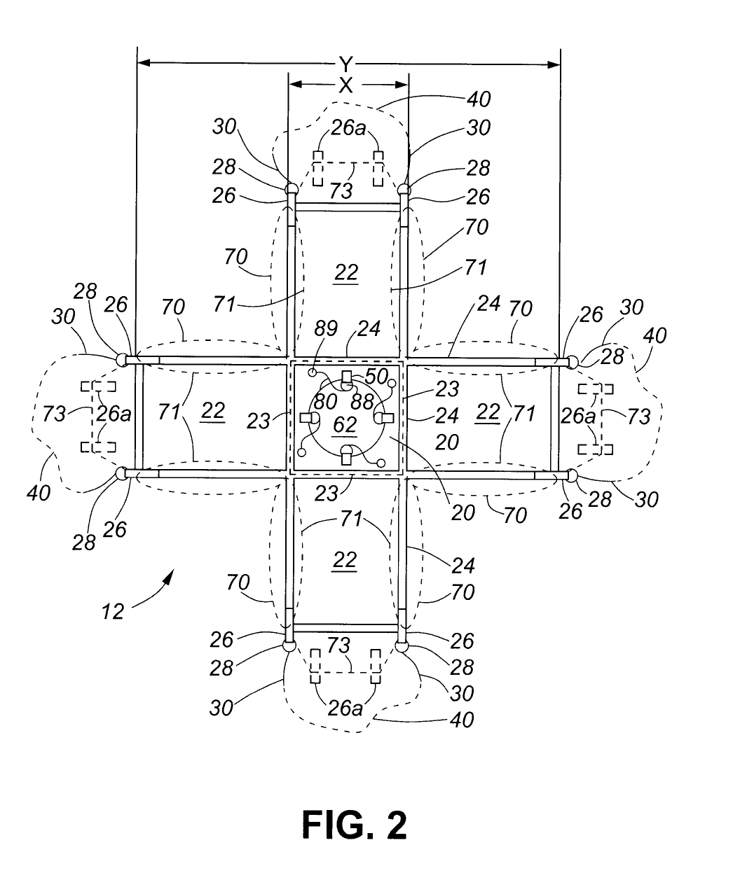

FIG. 2 shows a drogue 12. Similar numbers indicate similar parts to those described previously, and such parts will not be described further. The perimeter shape of the body portion is the same as body portion 20 of drogue 10, but the body portion has been modified as shown at 20a so that a hole 62 is placed in the centre of the body portion.

The size of the hole, counterintuitively, does not depend directly on the size of the drogue. Its purpose is to permit a small stream of fluid to escape downstream of the drogue. This is found to help keep the drogue near the centre line of the conduit or pipe, by reducing the pressure behind the drogue and thus limiting the intensity of vortices the buildup of vortices in the fluid just upstream from the body panel 20a.

Conveniently, the hole should be as small as possible while accomplishing this purpose. A larger hole than necessary will allow the escape of fluid which would otherwise provide useful pushing force to the device. Typically, circular holes of 1-3 inches in diameter have been found useful when the flow velocity of fluid in the conduit or pipeline is 1-3 feet per second, although other sizes of hole can be used.

As shown in the figure, securing means 50 preferably extend over the hole, so that the part where string 80 loops through the securing means 50 overlies the hole.

In a particularly preferred embodiment, the hole is large enough to permit a portion of an inspection device having a camera and a light source on it to protrude through it downstream of the drogue. This permits mounting of a light source and video or still camera on the protruding portion, so that the drogue does not impede the field of view of the camera in the downstream direction of the device. If the camera has a fish-eye lens, the camera can be made to protrude far enough so that it also has an unimpeded field of view for its full angle of view.

For example, where the portion of the inspection device is cylindrical and 2.5 inches in diameter, the hole 62 is preferably 4 inches in diameter. This permits the drogue some freedom of movement relative to the inspection device, while not allowing an undue amount of fluid to escape between the drogue and the inspection device, which would lower the pull of the drogue.

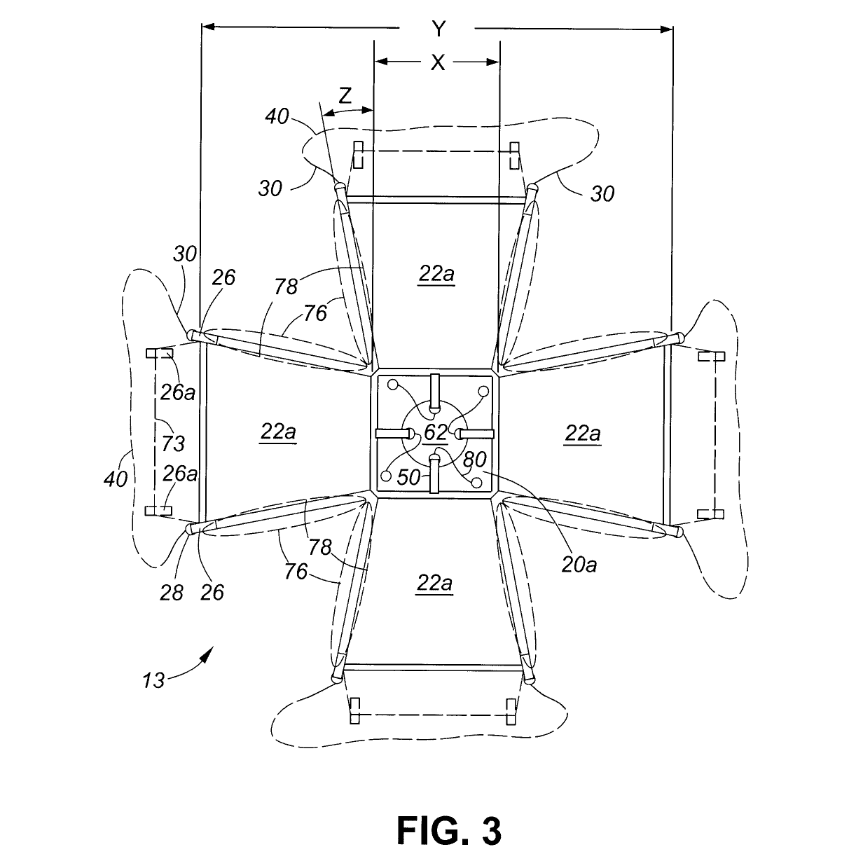

FIG. 3 shows a drogue 13, which differs from previously described drogues in the shape of its wings. Instead of having substantially rectangular wings, the wings 22a of drogue 13 are isosceles trapezoids, with the shorter parallel edge of the trapezoid adjoining the body portion. This permits a larger area of sailcloth for a given length of the side of the body portion than would be available with a rectangle, thus increasing the amount of pulling force for a given size of body portion. Drogue 13 is shown as having a central hole 62 and body panel 20a as in drogue 12. However, the wings 22a can be substituted for wings 22 in drogue 10 as well. The wing panels 22a can depart slightly from true isosceles trapezoids by having their non-parallel walls smoothly curved as shown by dashed lines 76 (when it is desired to increase the cross-sectional area of the panels and hence their drag or pulling force) or as shown by dashed lines 78 (when it is desired to decrease the cross-sectional areas slightly to decrease the pulling force and permit an increased amount of fluid to exit between adjacent wing portions). As discussed with respect to drogue 10, an extension 73 can be attached to each of wings 22a, with securing means 26a on such extension, when the drogue is to be used in conduits with sharp bends. In general, as discussed with respect to drogue 10, use of such extensions is not preferred.

Parts of drogue 13 which are the same as parts of drogue 10 or 12 have been given the same reference numerals, and will not be described further.

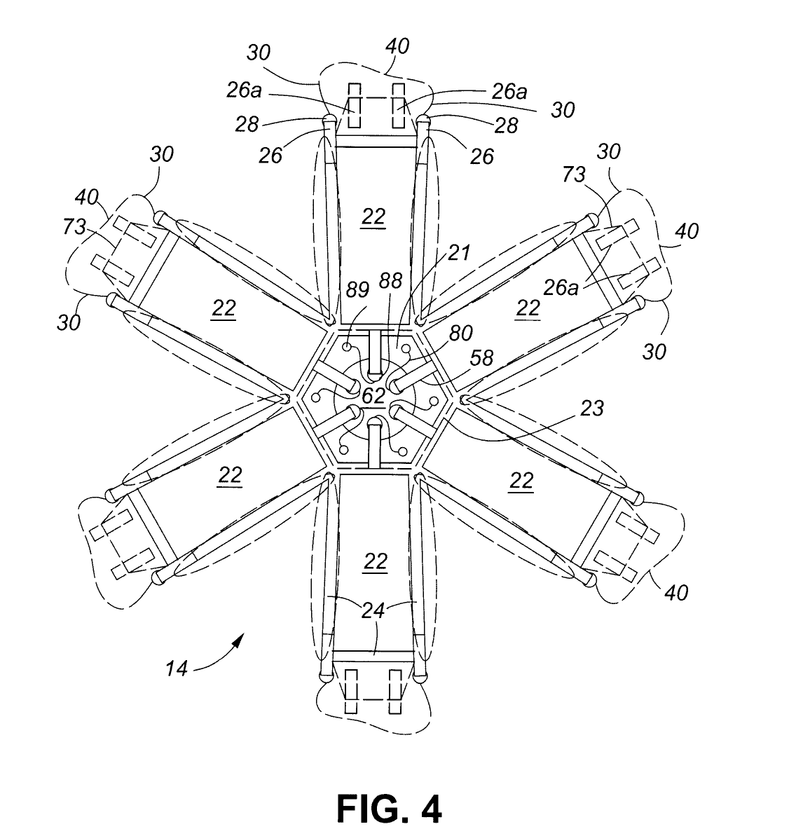

The drogues discussed above all have four wings. However, it is within the scope of the invention, although not preferred, to have a drogue with six wings or eight wings. A drogue 14 with six rectangular wings 22 is shown in FIG. 4. In it, like numerals designate like parts to those in the previously described drogues. The body panel, designated as 21, is a hexagon rather than a square, so that there are six edges, one each to attach to each wing 22. Securing means 50 are replaced by six securing means, each numbered 58 in the drawing. These are arranged at the mid-point of each side of the hexagon, which puts them also lying along the continuation of the centre line of each of the rectangular wings.

Drogues having six or eight wings can have wings which are isosceles trapezoids similar to wings 22a in FIG. 3 instead of rectangles. Also, the side walls can have a smoothly curved form, as shown in FIGS. 1 and 2 at 71 and 72, and in FIG. 3 at 76 and 78

Drogues having six or eight wings are not preferred because the increased number of wings means that there are more strings 30 and 50. The additional strings require more time for assembly when the drogue is assembled to the object to be pulled through the pipeline. It is found that, in most cases, a drogue with four wings is adequately stable and has adequate pulling force, so the additional complexity caused by additional wings is not necessary.

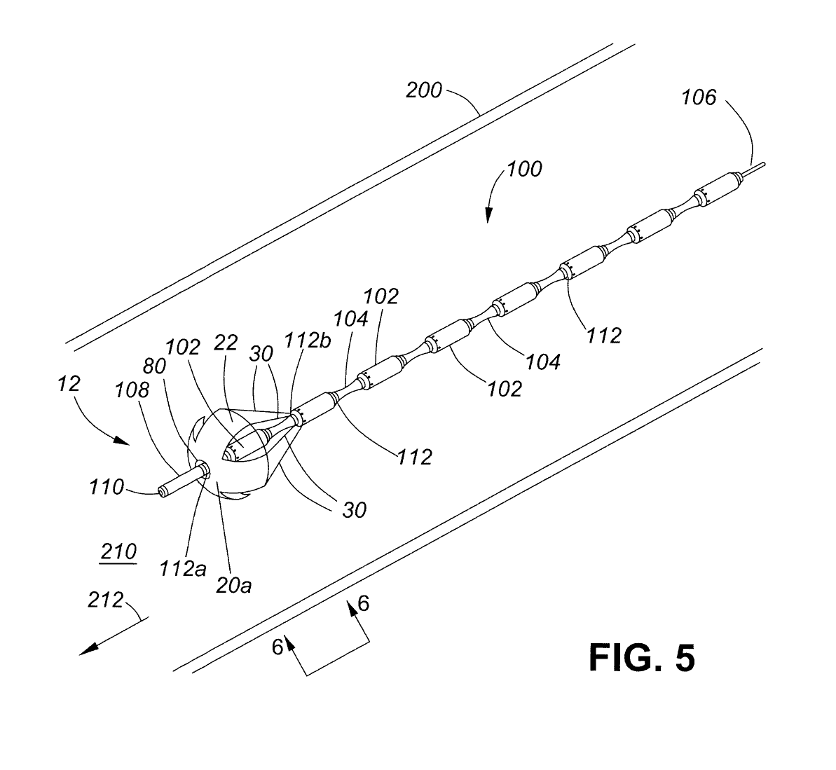

FIG. 5 shows a drogue 12 as shown in FIG. 2 connected to pull a tethered inspection device 100. Inspection device 100 is shown deployed in a pipeline 200, the walls of which are shown in phantom. The pipeline contains fluid 210 which is flowing in the direction of arrow 212. The fluid can for example be water, natural gas or oil, or other fluid typically carried by pipeline.

Inspection device 100 is comprised of modules 102 separated from one another by flexible joints 104. In the embodiment shown, each module is a cylinder approximately 4-6 inches in length, and 2.5 inches in diameter. The flexible joints 104 permit the inspection device to flex so that it can be inserted into a conduit or pipeline to be inspected through a manhole or inspection port as known in the art, and to flex as it goes around bends in the pipeline or conduit to be inspected. The flexible joints are hollow (not shown) to permit electrical and fiber optic communication between modules.

A tether 106 connects the inspection device through an inspection port or manhole (not shown) to surface equipment (not shown) which monitors various sensors mounted in or on modules 102. The inspection capacities and sensors of the particular inspection device do not form part of this invention, so will not be described in detail. The sensors, as well as the light source and camera to be described, are powered by any suitable means, such as batteries in one or more modules 102, or light gleaning apparatus to glean power from light transmitted through the tether 106, or by electrical wiring in the cable 106.

At the downstream end of the inspection device 100 (ie, the end in the direction 212 in which fluid 210 is flowing) is a camera module 108. In the embodiment described, module 108 is 2.5 inches in diameter. Its downstream end terminates in a transparent portion 110 behind which is a camera and a light source (not shown, as they are within module 108). The light source illuminates the portion of the pipeline downstream from module 108 so that the camera can take video or still pictures.

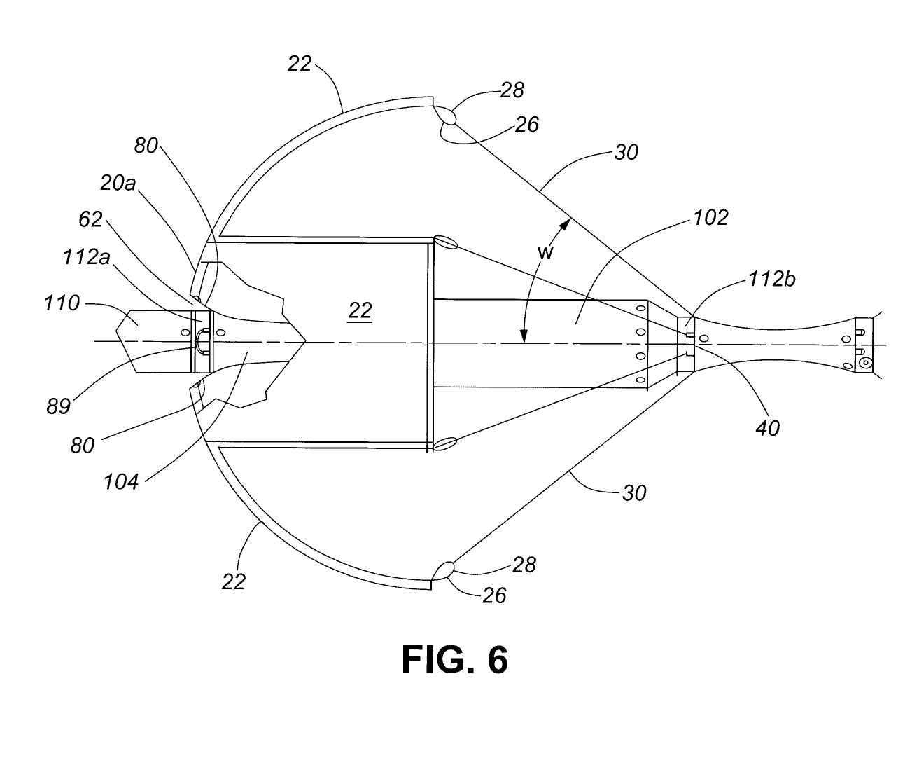

At each end of each flexible joint 104 is mounted a split collar 112, several of which are shown in more detail in FIG. 6. In FIG. 5, for clarity, only a few representative split collars have been indicated by reference numeral 112. Split collars 112 serve as attachment points for the strings connecting the drogue to the inspection device. Only two of the split collars are used to attach a drogue, but it is convenient to have split collars associated with each flexible joint 104 so that there will be a split collars 112 located at spaced points along the inspection device to accommodate drogues of different sizes. In FIG. 5, the two split collars used to attach the drogue are numbered 112a and 112b.

If desired, some other type of attachment, such as a ring and clip arrangement could be used instead of collars 112 as attachment points for the strings. It is merely necessary to have some means to attach the strings securely to the device 100.

In FIGS. 5 and 6, drogue 12 is arrayed on inspection device 100. Strings 30 from its wings 22 are attached to split collar 112b. For clarity, some stings have been omitted in FIG. 5.

Strings 80 are attached to split collar 112a. One of the wings 22 is partially cutaway to show the attachment of the strings to the collar 112a. One of the strings 80 has only its bowline 89 showing.

The drag of fluid 210 against the drogue causes it to move in a downstream direction, tightening the strings 30 and 80, thereby causing the drogue to assume the shape shown in FIGS. 5 and 6.

As best seen in FIG. 6, split collars 112 are provided with spaced notches 114. In the case where a drogue with four wings 22 is used, as in FIGS. 5 and 6, there are eight equally-spaced notches 114 around each split collar.

As best seen in FIG. 6, bowline 89 of one string 80 loops around the portion of collar 112a between two adjacent notches 114. Similarly, each of the other strings 80 is looped with its respective bowline around two adjacent notches so that the strings are spaced evenly around the perimeter of collar 112a and the effective length of each string between the collar 112a and the drogue is the same.

As best seen in FIG. 6, strings 30 joined by length 40 to make a single cord in use. The loop 40 is looped behind two adjacent notches 114 to hold it in place (it is shown in dashed form as it is hidden by the collar 114), and the loop is adjusted so that the two portions 30 are of equal length. Each of the other wing panels is similarly secured to two notches, so the strings are evenly around the perimeter of collar 112b and the effective length of the strings between the collar 112b and the drogue is the same.

Collars 112a and 112b are clamped shut after the strings are in place, as for example by a set screw (not shown), to prevent the strings from detaching.

The attachment of drogues 10 and 13 are each the same as shown for drogue 12, except that in the case of drogue 10 the object being pulled does not protrude through a hole in the drogue, as there is no hole.

It is preferred that the inventive drogue be used with a tethered inspection device for a pipeline in which both the inspection device and its tether are substantially of neutral density. It is found that the drogue of the invention, attached to the inspection device as described, provides very good stability of the inspection device, urging the device to the centre of the pipeline and reducing tendencies to move suddenly or scrape against the side of the pipe as compared to the same device used with a conventional drogue. While the inventor does not wish to be held to any particular theoretical explanation, it is believed that fluid is expelled when the drogue is in use in a pipeline or conduit in the gaps between adjacent wing panels 22 or 22a. As there is an even number of wing panels, there is also an even number of gaps resulting in fluid flowing generally radially outwards through gaps on opposite sides of the device, and that this tends to centre the device.

During the retraction of tethered drogues, as by a winch or like pull applied from the point at which they are tethered, the gaps between the wing panels also serve a useful function. Fluid expelled through the gaps tends to keep the drogue centred during retraction.

It is possible to use a second drogue of the form of drogue 12 or drogue 13 on a tether or cable at an intermediate location between the downstream end and the manhole or inspection port from which the tether extends. In some cases, several spaced drogues could be used. This may be useful to keep the tether or cable out of frictional contact with the pipe or conduit wall along its length. However, it is preferred not to use such additional drogues for most uses with inspection devices, and to space them as far apart as possible if they are used, to reduce the possibility of creating eddies in the pipeline fluid which could affect the stability of the inspection device.

Drogues of many different sizes can be used according to this invention. The choice of size is made according to the size of the object to be pulled, the degree of drag by the fluid 210 on the object to be pulled (which determines how much pulling force is needed), and the size of the conduit or pipeline. If the object to be pulled is substantially neutrally buoyant with respect to the fluid in the pipeline, the drag on the object tends to entrain the object and assist in pulling it along. However, if the object is of a markedly different density from the fluid in the pipeline, it may contact a wall and friction will require increased pulling force.

Many modern untethered inspection devices are designed to be moved through a conduit or pipeline without using a drogue. Therefore, use with untethered inspection devices is likely only in the case of elongated inspection devices which may need the help of a drogue to keep them oriented in or near the centre of the conduit to be inspected. It is expected therefore that the major use of the invention will be with tethered inspection devices or to lay cables in conduits.

A particularly preferred use of this invention is for the inspection of potable water pipelines. In such pipelines, it is desirable not to stir up sediment, which can make the potable water objectionable to users. It is also desirable to have an inspection device which can make several transits through a section of pipeline which is suspected to have imperfections or damage. When the drogue of the present invention is used with a tethered inspection unit, it is found that the unit can be pulled back slowly by a winch or similar device acting on it from the tether point, while not collapsing the drogue. This permits the inspection unit to make multiple passes through a potentially damaged section of the pipeline while not stirring up sediment unduly.

To illustrate typical dimensions of the drogues of this invention, distances X and Y are shown on FIGS. 1-3 and an additional angle Z is shown on FIG. 3. For drogues of the form of drogues 10 and 12, some typical dimensions in inches are:

| X | Y |
|---|---|
| 2.6 | 9.1 |
| 4 | 14 |
| 8 | 28 |
| 12 | 42 |

Drogues of the form of drogue 13 in FIG. 4 will have the same typical dimensions, and the angle Z (which is the same for all wing panels of a given drogue) can range from 0 degrees to about 20 degrees, with 10-12 degrees being preferred.

Generally, larger drogues give more pulling force, but the drogue chosen should not be any larger than that needed for the pulling force required, having regard to the increased likelihood of contacting the wall of the pipeline or conduit when the drogue size is increased. Often, not much pulling force is required, because the drag of the fluid on the cable or inspection device and tether will also urge it downstream, especially if its density is matched to the density of the fluid. For example, it has been found that a drogue of the form of drogue 13 in which x=8 inches and y=28 inches and z=11.5 degrees can successfully pull a tethered inspection unit of approximately neutral density and its tether of approximately neutral density, in a water pipe of eight foot diameter containing water flowing at 2 feet/second, over a distance of several kilometers, while keeping the inspection unit well centred in the pipe.

The pulling force can also be varied by changing the angle shown as “w” in FIG. 6. This angle is the angle between the strings and the axis of the inspection device, and can be varied by changing the length of strings 30 and their point of attachment to device 100. In the illustrated embodiment, changing the point of attachment would be done by choosing one of the other split collars 112 instead of the collar 112b chosen and changing the string length until the desired angle is achieved. If the angle “w” is increased, the pulling force is increased, but the edges of the drogue come closer to the wall of the conduit. If the angle “w” is decreased, problems may occur with the inflation of the drogue when it and the object it is pulling are initially put into the pipeline or conduit. Generally, an angle “w” of from 30 degrees to 60 degrees, and preferably close to 45 degrees, is found useful, but in some cases a larger or smaller angle may be desirable in particular pipeline geometries.

While the invention has been described with reference to particular embodiments, it is understood that variations will be evident to one skilled in the art, and the scope of the invention is intended to be as set out in the appended claims.

1. A drogue for use in confined spaces comprising
(a) a body panel,
(b) an even number of wing panels attached to and extending outwardly from the body panel, the wing panels being spaced evenly around the body panel
(c) securing means associated with the body panel, and
(d) securing means associated with the ends of the wing panels remote from the body panel.

2. A drogue as claimed in claim 1, having four wing panels evenly spaced from one another about the edges of the body panel.

3. A drogue as claimed in claim 1, having six wing panels evenly spaced from one another about the edges of the body panel.

4. A drogue as claimed in claim 1, having eight wing panels evenly spaced from one another about the edges of the body panel.

5. A drogue as claimed in claim 1, in which a portion of the body panel is transparent.

6. A drogue as claimed in claim 1, in which the body panel comprises a hole.

7. A drogue as claimed in claim 1, in which the body panel has a centred circular hole.

8. A drogue as claimed in claim 6, in which the securing means associated with the body panel extend over the edge of the hole.

9. A drogue as claimed in claim 1 in which the wing panels are substantially rectangular.

10. A drogue as claimed in claim 1 in which the wing panels are substantially isosceles trapezoids, with the shorter of their parallel sides adjoining the body panel.

11. A drogue as claimed in claim 1 in which the wing panels are substantially isosceles trapezoids, except that the non-parallel walls are not straight but are smoothly curved.

12. The combination of:
A. An inspection unit for inspection of a conduit or pipeline, said inspection unit having a first end adapted to be oriented downstream in the conduit or pipeline and a second end adapted to be oriented upstream of said first end
(i) first securing means for a drogue
(ii) second securing means for a drogue less proximate to said first end than the first securing means,
B. A drogue, having
(i) a body panel,
(ii) an even number of wing panels attached to and extending outwardly from the body panel, the wing panels being spaced evenly around the body panel
(iii) securing means associated with the body panel
(iv) securing means associated with the ends of the wing panels remote from the body panel
and
C. (i) flexible attaching means securing said first securing means to a drogue to said securing means associated with the body panel and
(iii) Flexible attaching means securing said second securing means to said securing means associated with the ends of the wing panels.

13. A combination as claimed in claim 12, in which said drogue has a central hole in said body panel and the first end of said inspection unit protrudes through said hole.

14. A combination as claimed in claim 12, in which the inspection unit is tethered at a tether point to surface equipment.

15. A combination as claimed in claim 12, in which the first end of the inspection unit comprises a camera and a light source adapted to be pointed downstream in said conduit or pipeline.
